(19) United States
(12) Patent Application Publication
(10) Pub. No.: US 2019/0082143 A1
(43) Pub. Date: Mar. 14, 2019

(54) METHOD AND APPARATUS FOR USER STATUS REMINDERS IN VIDEO COMMUNICATION

(71) Applicant: Alibaba Group Holding Limited, Grand Cayman (KY)

(72) Inventors: Qing Ren, Zhejiang (CN); Li Liu, Zhejiang (CN); Shuangxi Zheng, Zhejiang (CN); Jiankang Sun, Zhejiang (CN); Ziyu Zhou, Zhejiang (CN)

(21) Appl. No.: 16/191,124

(22) Filed: Nov. 14, 2018

Related U.S. Application Data
(63) Continuation of application No. PCT/CN2017/080192, filed on Apr. 12, 2017.

(30) Foreign Application Priority Data
May 18, 2016 (CN) 201610331685.7

(51) Int. Cl. H04N 7/14; H04N 7/15; H04N 21/431

(52) U.S. Cl. CPC H04N 7/147; H04N 21/4316; H04N 7/155; H04N 7/152

(57) ABSTRACT

A method and apparatus for user status reminders in video communication, wherein the method may include: during a video communication procedure between a current user and another user, detecting, by monitoring, an intervening communication event; and sending a reminder message regarding the intervening communication event to the other user, the reminder message being operative to instruct as to whether the current user has a need to respond to the intervening communication event. Through technical solutions of the present disclosure, users participating in video communication may comprehend mutual status change conditions at any time, facilitating performing timely adjustments to the procedure and content of the video communication.

### CROSS REFERENCE TO RELATED PATENT APPLICATIONS

This application claims priority and is a continuation of PCT Patent Application No. PCT/CN2017/080192, filed on Apr. 12, 2017, which claims priority to Chinese Patent Application No. 201610331685.7, filed on May 18, 2016 and entitled “METHOD AND APPARATUS FOR USER STATUS REMINDERS IN VIDEO COMMUNICATION”, which are incorporated herein by reference in their entirety.

### TECHNICAL FIELD

The present disclosure relates to the field of communication technology, and more particularly relates to a method and apparatus for user status reminders in video communication.

### BACKGROUND

When multiple users are at different places, such as when personnel are located between a company's headquarters and divisions, a video conference may be convened, thereby eliminating limitations arising from geographical location. Traditional video conferencing requires utilizing dedicated video and communications equipment, which is not only expensive, but also must be installed fixed at locations such as conference rooms and the like, etc., so that considerable use limitations remain.

Pertinent art sets forth configuring video communication functionality on mobile phones, laptops and such portable electronic devices, enabling users to make use of video communication functionality from nearly any location, enhancing flexibility of usage.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of this, the present disclosure provides a method and apparatus for user status reminders in video communication, which may enable users participating in video communication to, at any time, comprehend each other's respective status changes, in order to adjust the video communication procedure and content on a timely basis.

To achieve the above-mentioned objectives, the present disclosure provides the following technical solutions:

According to an embodiment of the present disclosure, a method for user status reminders in video communication is set forth, comprising:

During a video communication procedure between a current user and another user, detecting, by monitoring, an intervening communication event;

Sending a reminder message regarding the intervening communication event to the other user, the reminder message being operative to instruct as to whether the current user has a need to respond to the intervening communication event.

According to an embodiment of the present disclosure, a method for user status reminders in video communication is set forth, comprising:

During a video communication procedure between a current user and another user, receiving a reminder message regarding the other user, the reminder message being operative to instruct as to whether the other user has a need to respond to the intervening communication event;

Based on the reminder message, adjusting display contents of a video window corresponding to the other user on a video communication page.

According to an embodiment of the present disclosure, an apparatus for user status reminders in video communication is set forth, comprising:

A monitoring unit, which, during a video communication procedure between a current user and another user, detects, by monitoring, an intervening communication event;

A sending unit, which sends a reminder message regarding the intervening communication event to the other user, the reminder message being operative to instruct as to whether the current user has a need to respond to the intervening communication event.

According to an embodiment of the present disclosure, an apparatus for user status reminders in video communication is set forth, comprising:

A receiving unit, which, during a video communication procedure between a current user and another user, receives a reminder message regarding the other user, the reminder message being operative to instruct as to whether the other user has a need to respond to the intervening communication event;

An adjusting unit, which, based on the reminder message, adjusts display contents of a video window corresponding to the other user on a video communication page.

By the above-mentioned technical solutions it may be seen that, through detecting, by monitoring, an intervening communication event during a video communication procedure, whether the current user has a need to respond to the intervening communication event is determined, and thereby through sending a reminder message to another user participating in the video communication, the other user is able to comprehend the participation condition of the current user with regard to the video communication on a timely basis, such as whether the current user, due to a need to respond to an intervening communication event, is temporarily unable to participate in the video communication, in order for the other user to adjust the video communication procedure and content on a timely basis.

### BRIEF DESCRIPTION OF THE DRAWINGS

FIG. 1 is a flowchart of a method for user status reminders based on a first side user of video communication provided by an exemplary example embodiment of the present disclosure.

FIG. 2 is a flowchart of a method for user status reminders based on another side user of video communication provided by an exemplary example embodiment of the present disclosure.

FIG. 3 is a flowchart of a method for user status reminders in video communication provided by an exemplary example embodiment of the present disclosure.

FIGS. 4A-12 are interface diagrams of user status reminders in video communication provided by an exemplary example embodiment of the present disclosure.

FIG. 13 is a flowchart of another method for user status reminders in video communication provided by an exemplary example embodiment of the present disclosure.

FIG. 14 is a schematic diagram of an electronic device provided by an exemplary example embodiment of the present disclosure.

FIG. 15 is a block diagram of an apparatus for user status reminders based on a first side user of video communication provided by an exemplary example embodiment of the present disclosure.

FIG. 16 is a schematic diagram of another electronic device provided by an exemplary example embodiment of the present disclosure.

FIG. 17 is a block diagram of an apparatus for user status reminders based on another side user of video communication provided by an exemplary example embodiment of the present disclosure.

### DETAILED DESCRIPTION

In the pertinent technology, when users A, B, C, etc. participate in video communication, if user A during a video communication procedure answers a call from user D, user A will be unable to participate in video communication, but since users B, C, etc. do not comprehend that user A is in a call, users B, C, etc. are caused to advance the video communication procedure as normal, which may cause user A to miss important communication content, even impacting subsequent execution of related communication content.

Thus, the present disclosure, through user status reminders in the procedure of video communication, solves the above-mentioned problems in the pertinent technology. To further describe the present disclosure, example embodiments are provided as follows:

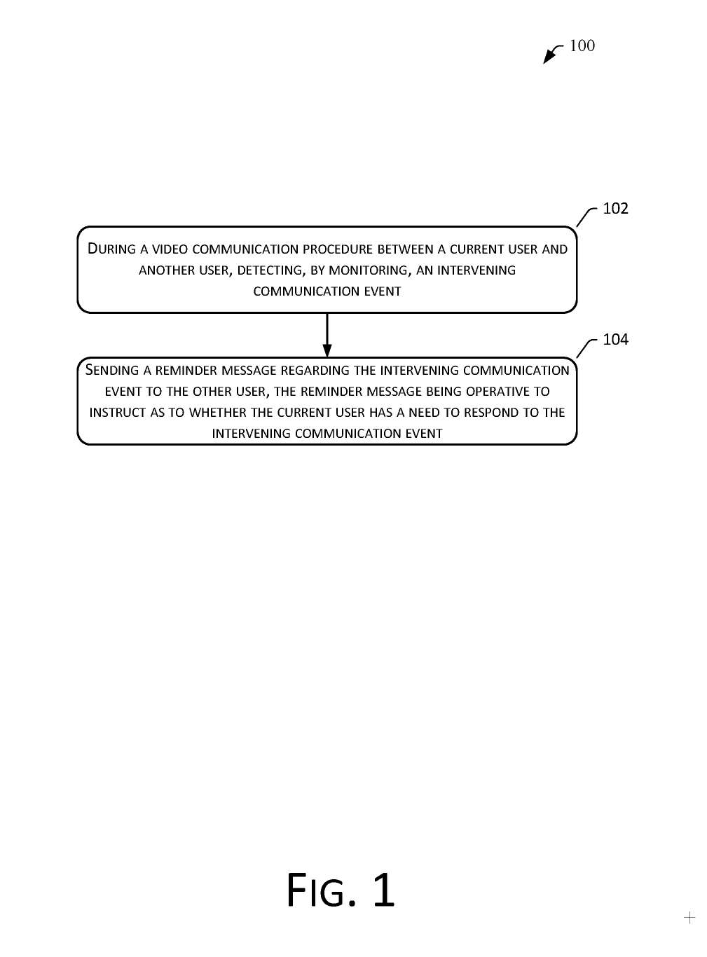

FIG. 1 is a flowchart of a method 100 for user status reminders based on a first side user of video communication provided by an exemplary example embodiment of the present disclosure. As illustrated by FIG. 1, the method 100 utilizes an electronic device of a first side user, and may include the following steps:

Step 102, during a video communication procedure (for example, a video conference procedure) between a current user and another user, detecting, by monitoring, an intervening communication event.

Step 104, sending a reminder message regarding the intervening communication event to the other user, the reminder message being operative to instruct as to whether the current user has a need to respond to the intervening communication event.

According to one example embodiment, with regard to detecting, by monitoring, an intervening communication event, it may be directly decided that the current user has a need to respond to the intervening communication event, and actual processing operations of the current user towards the intervening communication event need not be regarded. For example, when the intervening communication event is a call event, only a call request of the call event need be detected to decide that the user has a call request, and whether the user connects or disconnects need not be regarded.

For example, whether an intervening communication event exists may be recognized based on a running status of an application process of the video communication, thereby determining whether the current user has a need to respond to the intervening communication event, and a concordant reminder message is sent to the other user. Herein, upon detecting, by monitoring, that the application process of the video communication is switched to a background running status, it is determined that the current user has a need to respond to the intervening communication event; upon detecting, by monitoring, that the application process of the video communication is restored from a background running status to a foreground running status, it is determined that the current user does not have a need to respond to the intervening communication event.

According to another example embodiment, whether the current user has a need to respond to the intervening communication event may be determined based on a processing operation of the user towards the intervening communication event, and a concordant reminder message is sent to the other user. Herein, when the processing operation is a connecting response operation with regard to the intervening communication event, it is determined that the current user has a need to respond to the intervening communication event; when the processing operation is a disconnecting operation with regard to the intervening communication event, it is determined that the current user does not have a need to respond to the intervening communication event.

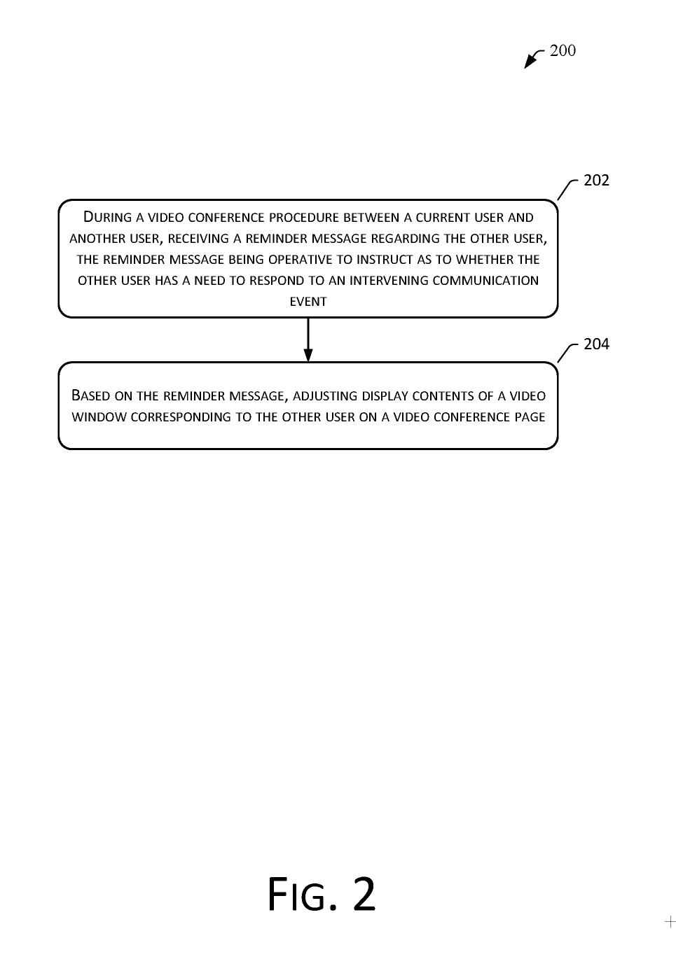

Concordantly, FIG. 2 is a flowchart of a method 200 for user status reminders based on another side user of video communication provided by an exemplary example embodiment of the present disclosure. As illustrated by FIG. 2, the method 200 utilizes an electronic device of another side user, and may include the following steps:

Step 202, during a video communication procedure (for example, a video conference procedure) between a current user and another user, receiving a reminder message regarding the other user, the reminder message being operative to instruct as to whether the other user has a need to respond to an intervening communication event.

Step 204, based on the reminder message, adjusting display contents of a video window corresponding to the other user on a video communication page (for example, a video conference page).

According to the present example embodiment, when the other user has a need to respond to the intervening communication event, user status information corresponding to the need to respond is displayed in the video window; when the other user does not have a need to respond to the intervening communication event, a video image of the other user is displayed in the video window.

By the above technical solution it may be seen that, the present disclosure through detecting, by monitoring, an intervening communication event during a video communication procedure, determines whether the current user has a need to respond to the intervening communication event. Thereby, through sending a reminder message to another user participating in the video communication, the other user is able to comprehend the participation condition of the current user with regard to the video communication on a timely basis, such as whether the current user, due to a need to respond to an intervening communication event, is temporarily unable to participate in the video communication, in order for the other user to adjust the video communication procedure and content on a timely basis.

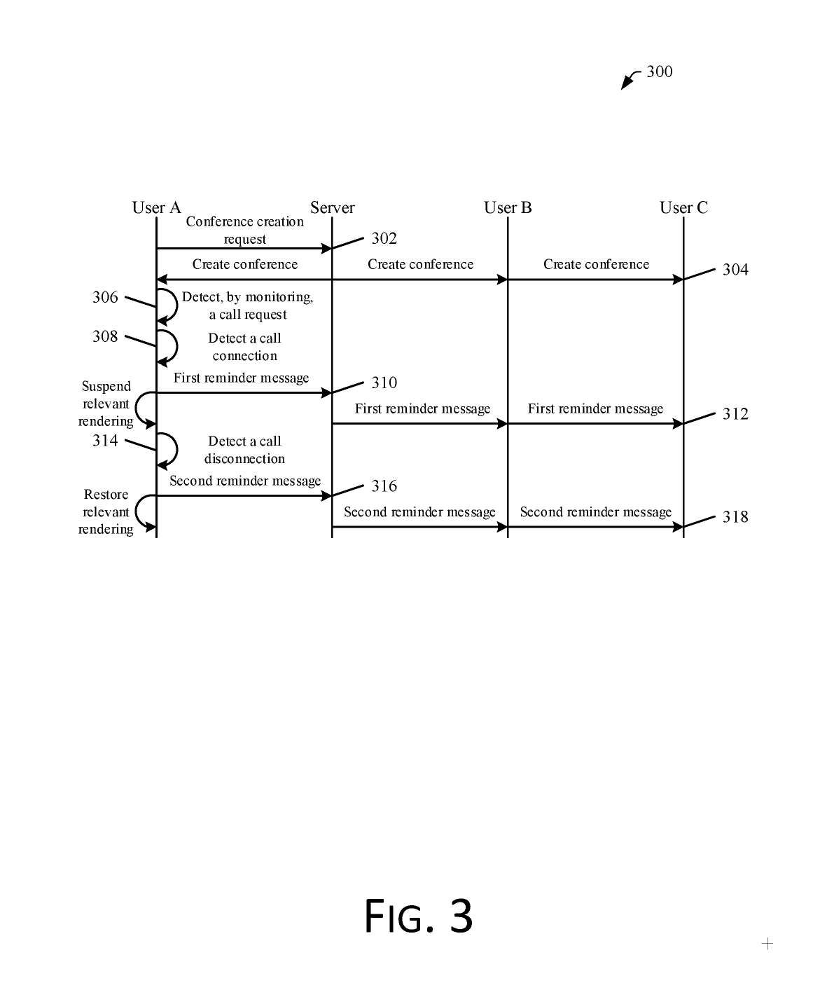

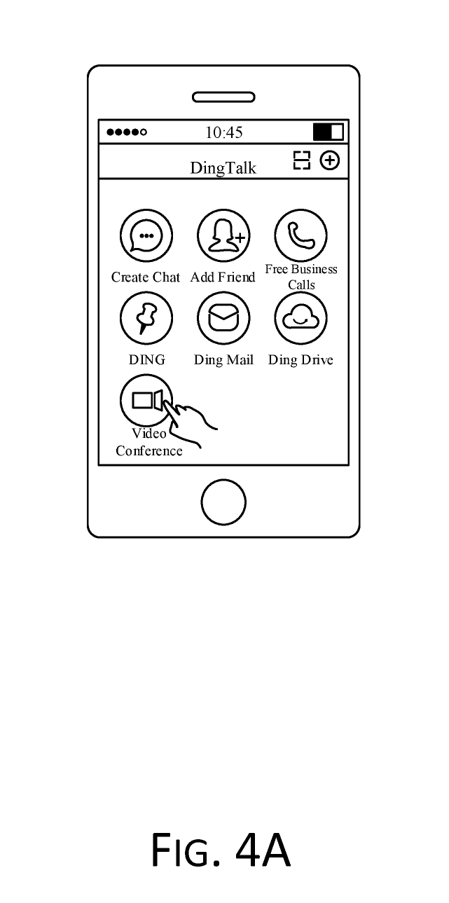

Below, incorporating an interaction procedure between a pair of users corresponding to a reminder operation in video communication, technical solutions of the present disclosure are described in detail; herein, FIG. 3 is a flowchart of a method 300 for user status reminders in video communication provided by an exemplary example embodiment of the present disclosure. As illustrated by FIG. 3, the method 300 may include the following steps:

Step 302, user A initiates a conference creation request to a server.

According to the present disclosure, user A, user B and user C implement operations and communication through electronic devices, where the electronic devices may be mobile phones, tablets and the like, which shall not be limited by the present disclosure. Herein, application programs which may implement video communication and such communication functionality are installed on the electronic devices, to implement video communication, calling and such various communication operations of the present disclosure. Given this, persons skilled in the art will appreciate that: to facilitate description, below, descriptions such as, for example, “user A and user B implement communication” should in fact be read as user A and user B respectively, through respective electronic devices, implementing communication.

By way of example, the above-mentioned application programs may be instant messaging applications, such as DingTalk and such enterprise instant messaging (EIM) applications. Given this, user A, user B and user C and the like, through the manipulation of function pages of DingTalk, are able to implement corresponding application functions, such as video communication and the like. To facilitate description and understanding, below-mentioned example embodiments all describe technical solutions of the present disclosure with DingTalk as an example with regard to video communication settings in enterprise environments, such as “video conferencing” settings.

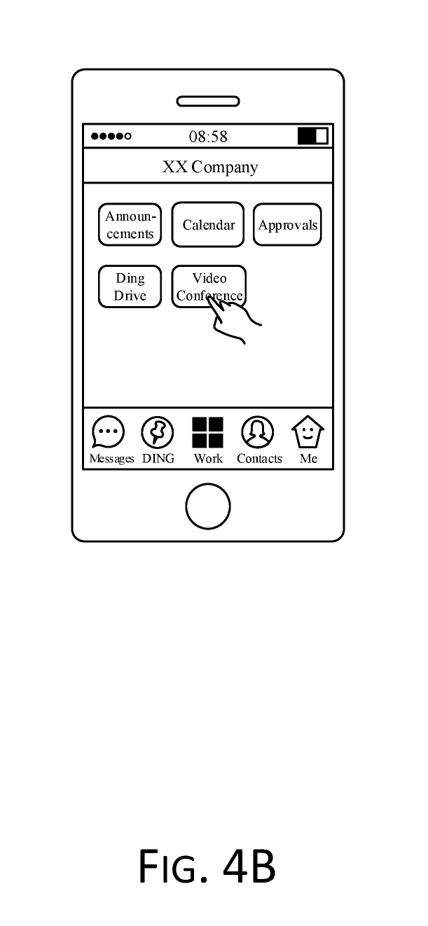

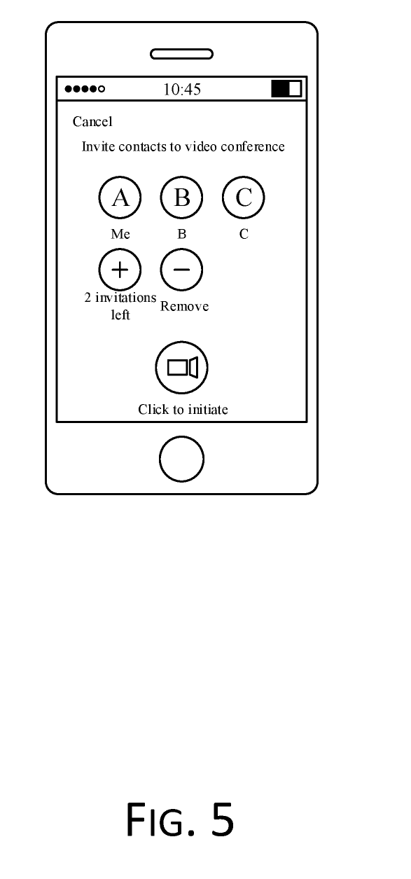

As illustrated by FIG. 4A, in a function selection page provided by DingTalk, a function icon and descriptive text regarding “video conferencing” are provided; of course, “video conferencing” may be triggered through other methods. For example, the page labeled “Work” as illustrated by FIG. 4B also provides a function icon regarding “video conferencing,” and so upon detecting a trigger operation of a user towards a “video conferencing” function icon of FIG. 4A or FIG. 4B, the page may be switched to a contact configuration page as illustrated by FIG. 5, to “Invite contacts to video conference,” for example, user A has already invited user B and user C to participate in a video conference.

Upon detecting user A triggering the “⊕” icon on the contact configuration page as illustrated by FIG. 5, other users may be further invited to be added to the video conference; when a video conference has a participant limit, supposing that the limit is a maximum of five individuals being supported simultaneously, then as illustrated by FIG. 5, below the “⊕” icon “2 invitations left,” for example, may be displayed, indicating that aside from the already currently determined user A (that is, “Me”), user B and user C, two users may be further invited to be added to the current video conference. Upon detecting user A triggering the “⊖” icon on the contact configuration page as illustrated by FIG. 5, an already invited user may be removed.

After determining all contacts needing to be invited, upon detecting user A performing a trigger operation upon the bottommost “Click to initiate” on the page illustrated by FIG. 5, the electronic device may, through DingTalk, initiate a corresponding conference creation request to a DingTalk server.

Step 304, creating a video conference.

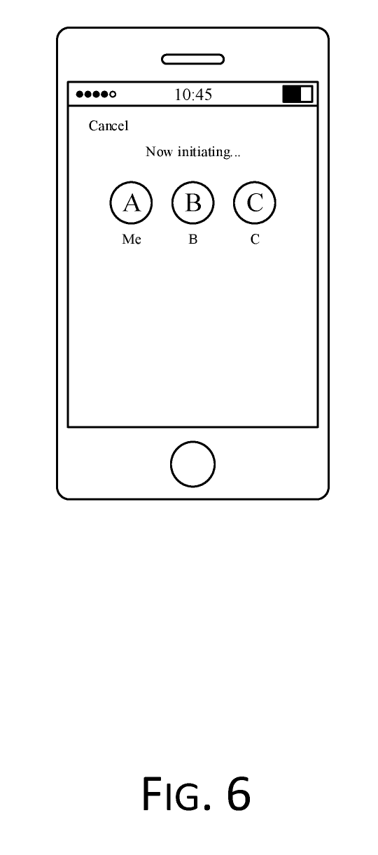

According to the present example embodiment, FIG. 6 illustrates a waiting page while creating a video conference according to an exemplary example embodiment, where user A may, through triggering “Cancel” at an upper left corner of the page, terminate creating the present video conference.

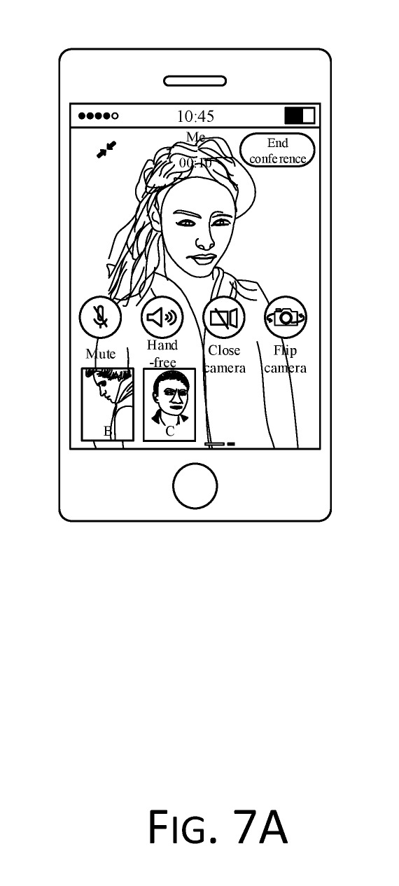

After a video conference is successfully created, FIG. 7A illustrates a video conference page on the electronic device of user A, the background of the page being a video image acquired by a camera of the electronic device of user A, and the bottom of the page shows video windows respectively corresponding to user B, user C and such other conference participants, each video window respectively showing a video image acquired by a camera of an electronic device of the corresponding user. Herein, the video conference page may further contain other function buttons, such as “Mute,” “Hand-free,” “Close camera,” “Flip camera” and the like, utilized to implement corresponding control functions; upon detecting a preset hiding operation of the current user, such as a click, double-click or long press operation and the like on a background area of a screen of the electronic device, the above-mentioned function buttons as illustrated by FIG. 7A may be hidden, causing a page display mode to be switched from a normal mode illustrated by FIG. 7A to a hidden mode illustrated by FIG. 7B, to avoid the function buttons obstructing the video image, facilitating the current user viewing the video image. Herein, the video conference page does not necessarily utilize video images acquired by the camera of the electronic device of the current user, for example, upon detecting a selection operation by user A upon a video window of user B or user C or the like as illustrated by FIG. 7A, the video image of the selected video window may be configured as the background of the video conference page, and the selected video window is configured to correspond to the current user, that is, user A, the video image acquired by the camera of the electronic device of user A being shown in the video window.

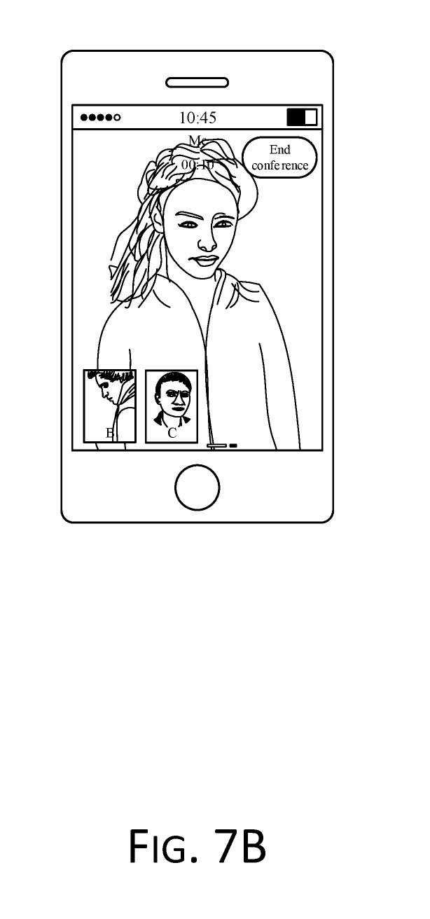

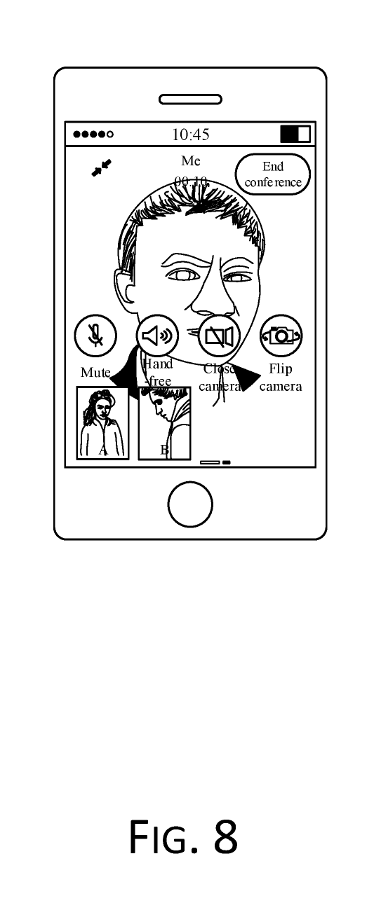

Analogously, FIG. 8 illustrates a video conference page on the electronic device of user C. Aside from replacing the page background with a video image acquired by a camera of an electronic device of user C, the bottom of the page shows video windows respectively corresponding to user A, user B and such other conference participants, the layout of the entire video conference page being analogous to FIG. 7A, which shall not be repeated herein.

Step 306, an electronic device of user A detecting, by monitoring, a call request.

According to the present example embodiment, while the electronic device of user A participates in the above-mentioned video conference procedure, if a call request targeting itself is detected by monitoring, this is equivalent to a communication event occurring intervening during the video conference, that is, an intervening communication event. Types of intervening communication events are not limited to types of calls; for example, the intervening communication event may also be another video conference initiated by another user. The present disclosure shall not be limiting with regard to types of intervening communication events.

Of course, intervening communication events should be implemented utilizing different communication methods than video conferences, so as to ensure that intervening communication events do not result in interrupting a video conference. By way of example, when an intervening communication event is a call request, the communication event is implemented through a mobile communication circuit-switched (CS) domain, and the video conference may be implemented through a mobile communication packet-switched (PS) domain or through, for example, a Wi-Fi network.

According to an exemplary embodiment of the present application, based on a processing operation of the current user towards the intervening communication event, whether the current user has a need to respond to the intervening communication event may be determined, to transmit concordant reminder messages to other users. Below, the example embodiment is described in detail through steps 308-318 illustrated by FIG. 3:

Step 308, the electronic device of user A detects a call connection.

According to the present example embodiment, based on a processing operation of user A towards the intervening communication event, whether user A has a need to respond to the intervening communication event is determined. Taking a call event as an example: when the electronic device detects the call request, if detecting a connecting response operation of user A, the call request is connected, and user A is considered to have a need to respond to the call request.

Step 310, the electronic device of user A sending a first reminder message to the server, and suspends relevant local rendering.

Step 312, the server sends the first reminder message to user B, user C and the like.

According to the present example embodiment, through the electronic device of user A, the first reminder message may be sent to a server (when taking DingTalk as an example, a server being a DingTalk server), and the server, in turn, notifies user B, user C, and such other participants of the video conference, causing these participants to comprehend whether user A has a need to respond to the intervening communication event (such as the above-mentioned communication event), thus adjusting display content of a video window corresponding to user A on a video conference page of each's own electronic device.

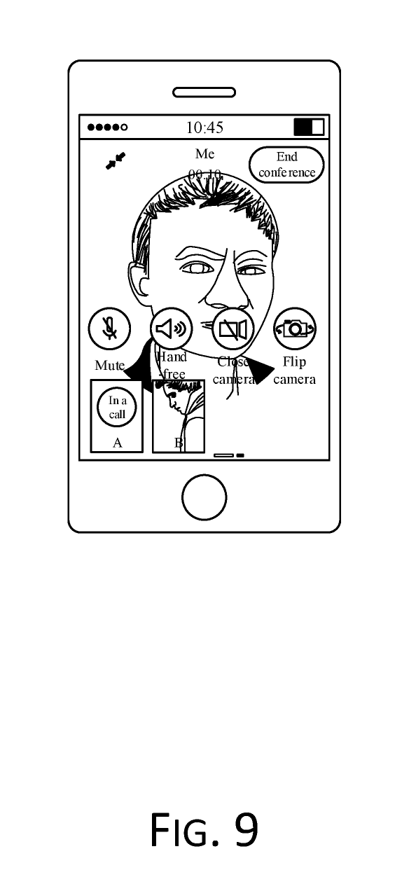

With user C as an example: when a need to respond exists, targeting the video window corresponding to user A on the video conference page illustrated by FIG. 8, the electronic device of user C may show user status information corresponding to the need to respond in the video window (that is, switching the video image in the video window to user status information corresponding to the need to respond). For example, “In a call” as illustrated by FIG. 9, or other content, prompts user C that user A is performing a “calling” type intervening communication event, and may temporarily be unable to participate in a video conference; similarly, user B and such other users may also view relevant user status information on their own electronic devices. Given this, when the video conference participants comprehend that user A is currently handling, for example, a “calling” type intervening communication event, these users may avoid important content or directly pause the progress of convening the video conference, until user A returns to the video conference, thereby avoiding user A missing relevant video conference content. Especially with regard to a setting of comparatively important enterprise video conferences, user A is prevented from missing hearing relevant conference content which would impact relevant work progress, having important enterprise administrative significance.

Additionally, in terms of the electronic device of user A, to ensure user A responds normally to an intervening communication event, the electronic device, when the video conference is to be preserved, may suspend rendering operations relevant to the video conference, such as pausing display output for the video conference page and utilization of devices such as a camera and a microphone, and switch to rendering operations relevant to the intervening communication event, such as outputting a corresponding calling page, utilization of a microphone and such devices, and so on.

Of course, although the example embodiment illustrated by FIG. 3, such as the above-mentioned first reminder message (and the below-mentioned second reminder message and the like), needs to be forwarded by the server between user A, user B, and user C, in fact user A may evidently also directly send to user B and user C through point-to-point communication, without needing the server to perform forwarding; the present disclosure shall not be limiting thereto.

Step 314, the electronic device of user A detects a call disconnection.

According to the present disclosure, responses of user A to an intervening communication event further include a disconnecting operation with regard to the intervening event. Still taking a call event as an example: after the electronic device detects the above-mentioned connecting response operation and connects the call, if a disconnecting operation of user A is detected, disconnecting the call event, it is believed that user A does not have a need to respond to the call event.

Step 316, the electronic device of user A sends a second reminder message to the server, and restores relevant local rendering.

Step 318, the server sends the second alert message to user B, user C and the like.

According to the present example embodiment, similarly to steps 310-312, the electronic device of user A may send the second reminder message to the server (when taking DingTalk as an example, a server being a DingTalk server), and the server, in turn, notifies user B, user C, and such other participants of the video conference, causing these participants to comprehend whether user A has a need to respond to the intervening communication event (such as the above-mentioned communication event), thus adjusting display content of a video window corresponding to user A on a video conference page of each's own electronic device.

Still with user C as an example: when a need to respond does not exist, the electronic device of user C may utilize the method illustrated by FIG. 8, that is, in the video window of the video conference page corresponding to user A, show a video image of the electronic device of user A; in particular, a scenario of switching from having a need to respond to not having a need to respond shall be understood as: the electronic device of user C may restore from a video conference page illustrated by FIG. 9 (that is, the video window corresponding to user A showing user status information corresponding to a need to respond) to the video conference page illustrated by FIG. 8 (that is, the video window corresponding to user A showing a video image from the electronic device of user A). Similarly, user B and such other users may also view the display or restoration of relevant video images on each's own electronic device.

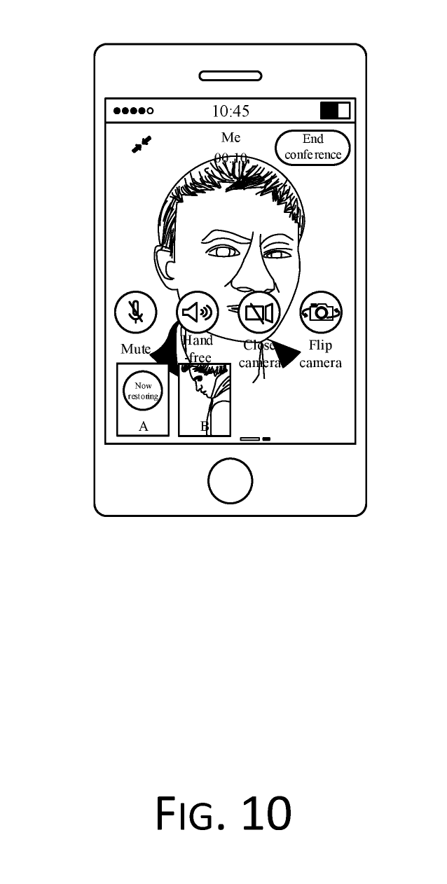

Furthermore, while the electronic device of user A is ending an intervening communication event, that is, upon detecting, by monitoring, that a processing operation of user A towards the intervening communication event is a disconnecting operation towards the intervening communication event, rendering operations relevant to the video conference may be restored, including restoring the display of the conference page, utilization of a camera and a microphone, and the like. Additionally, after the electronic device of user A ends the intervening communication event, it may still be necessary to adjust communication configuration with regard to video conferencing, in order to provide an optimal communication outcome. Given this, in terms of user B, user C and the like, while executing the above-mentioned processing operation on the electronic device of user A, there may be no way to immediately restore the display of the video image of the electronic device of user A, and thus as illustrated by FIG. 10, a message such as, for example, “Now restoring” may be displayed in video windows corresponding to user A, to prompt user B, user C and the like to patiently wait.

It should be stated that:

When evaluating whether the user has a need to respond to the intervening communication event based on the processing operation of the current user (such as the above-mentioned user A), aside from the disconnection operation described in step 314 with regard to an already connected call event, it is also possible to, in step 308, directly hang up an unconnected call event, that is, perform a disconnecting operation upon an unconnected intervening communication event. A processing method that may be employed at this time being: in one scenario, it may be decided that when the current user does not have a need to reply to the intervening communication event, then the electronic device of the current user (taking user A as an example) may send reminder messages (similar to the second reminder information of steps 316-318, indicating that the current user does not have a need to respond to the intervening communication event) to other users participating in the video conference (taking user B and user C as examples), causing the electronic devices of user B and user C to, in a video window corresponding to user A on a video conference page, show a video image from the electronic device of user A. Since the electronic devices of user B and user C originally showed a video image from the electronic device of user A in this video window, effectively no change in display occurred. In another scenario, since there is no impact (or minimal impact) upon participation of the current user in the video conference, and as described above, in fact no change in display occurs on the electronic devices of for example user B, user C and such other users, thus the corresponding intervening communications event may be ignored, and no conveyance of reminder messages regarding a need to respond is performed.

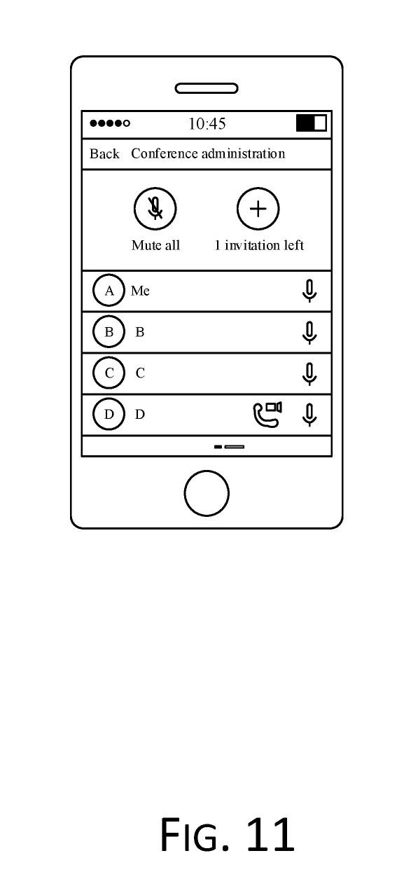

Additionally, according to technical solutions of the present disclosure, participants of a video conference may also administrate the video conference. Taking the electronic device of user A, the initiator of a video conference, as an example, suppose that the electronic device detects user A executing a present user operation upon the video conference page illustrated by FIG. 7A, such as sliding the video conference page to the left, the page may then be switched to a conference administration page as illustrated by FIG. 11. As illustrated by FIG. 11, user A may respectively click on microphone icons to the right of the icons of user B, user C, and such users, to implement a muting administration for the corresponding users, and user A may also, through triggering the “Mute all” function in the upper part of the page, implement a muting administration for all users at the same time.

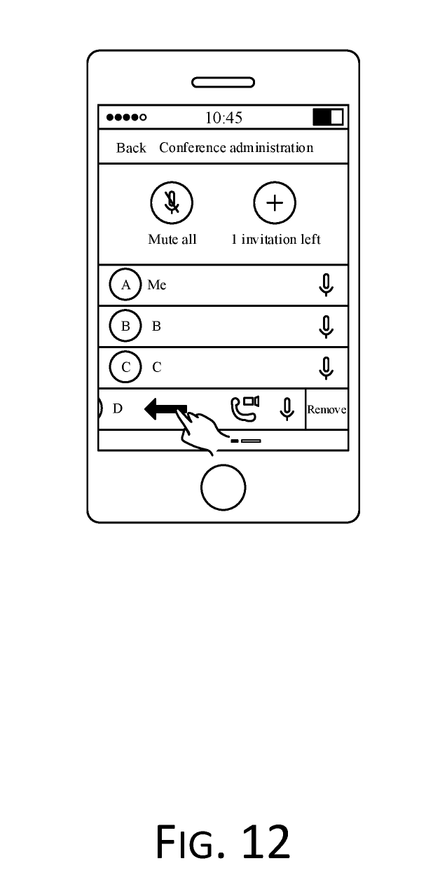

User A may also, through the conference administration page illustrated by FIG. 11, add or remove a user participating in the video conference. For example, when participants in the video conference are limited to five, since the conference administration page illustrated by FIG. 11 already contains the four participants of user A, user B, user C and user D, “1 invitation left” may be shown under the “⊕” icon, indicating that user A may at most add one user to the current video conference. As illustrated by FIG. 12, user A may also through, for example, sliding the administration window corresponding to user D to the left, reveal a “Remove” button, and upon detecting a trigger operation of user A upon the “Remove” button, user D is removed from the current video conference.

In the conference administration page illustrated by FIGS. 11-12, when user D is not yet successfully added to the video conference, such as when user D has not received a conference adding invitation, has declined to join, and the like, a resend icon may be shown within a corresponding administration window, that is, the icon to the left of the “microphone” icon in FIGS. 11-12, so that upon detecting a trigger operation of user A upon the resend icon, a resent request may be sent to user D, to re-invite user D to join the current video conference.

User B, user C and such non-initiating users, based on actual configurations, may have the same administrative permissions to implement the above-mentioned various administrative functions of FIGS. 11-12 as user A, the initiator of the video conference; or, they may only have some of the administrative permissions of user A, for example, only muting permissions, and no inviting or removing permissions; or, non-initiating users may not be granted administrative permissions.

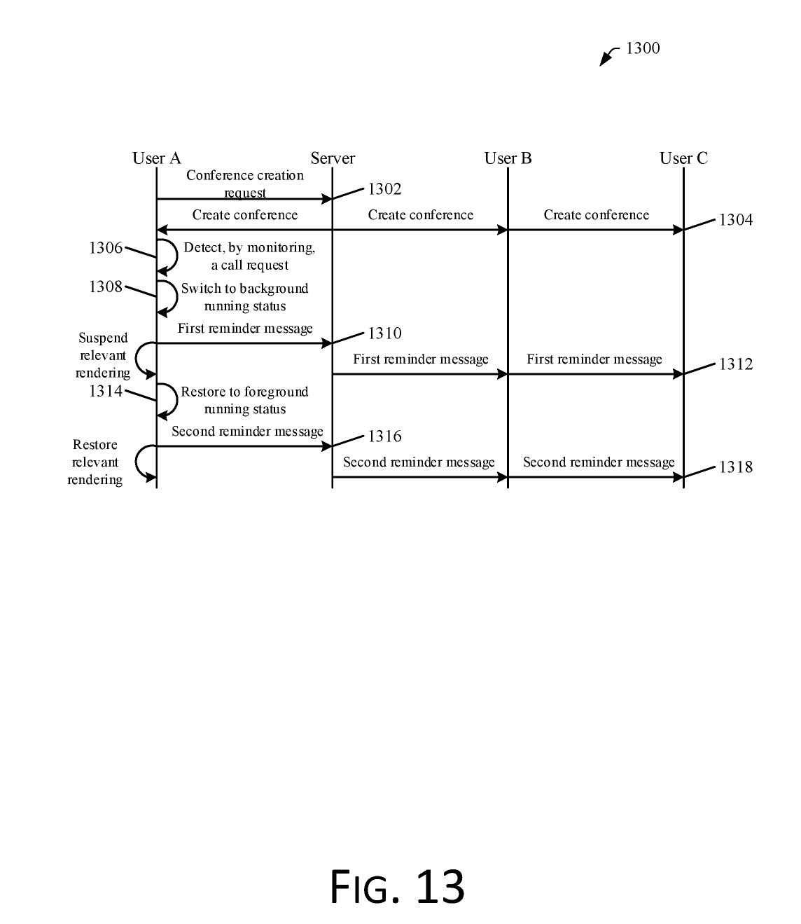

FIG. 13 is a flowchart of another method 1300 for user status reminders in video communication provided by an exemplary example embodiment of the present disclosure. As illustrated by FIG. 13, the method 1300 may include the following steps:

Step 1302, user A initiating a conference creation request to a server.

Step 1304, creating a video conference.

Step 1306, an electronic device of user A detecting, by monitoring, a call request.

According to the present example embodiment, steps 1302-1306 may reference steps 302-306 as illustrated by FIG. 3, which shall not be repeated herein.

According to an exemplary embodiment of the present disclosure, based on a running status of the application process of a video conference, whether the current user has a need to respond to the intervening communication event may be determined, to transmit concordant reminder messages to other users. Below, the example embodiment is described in detail through steps 1308-1318 illustrated by FIG. 13:

Step 1308, the electronic device of user A switches an application process of the video conference to a background running status.

According to the present example embodiment, upon detecting, by monitoring, that an application process of the video conference is switched to a background running status, the application process may lose permissions over screen display, speaker playback, camera acquisition, and such aspects, impacting the normal implementation of the video conference, and thus it may be decided that user A has a need to respond to a corresponding intervening communication event, regardless of whether user A has executed a connecting response operation, a disconnecting operation or no processing towards the intervening communication event.

In other words, upon detecting, by monitoring, an intervening communication event, as long as the intervening communication event results in the application process of the video conference switching to a background running status, it is decided that the current user has a need to respond to the intervening communication event. For example, the intervening communication event may be a call event having permissions over screen display, speaker playback and the like; with regard to some other types of intervening communication events, such as receiving mail in the background, instant messaging and such, since they do not result in the application process of the video conference switching to a background running status, it may be decided that the current user does not have a need to respond to the intervening communication event.

Step 1310, the electronic device of user A sends a first reminder message to a server, and suspends relevant local rendering.

Step 1312, the server sends the first reminder message to user B, user C and the like.

According to the present example embodiment, steps 1310-1312 may reference steps 310-312 as illustrated by FIG. 3, which shall not be repeated herein.

Step 1314, the electronic device of user A restores the application process of the video conference from a background running status to a foreground running status.

According to the present example embodiment, when the application process of the video conference is restored to a foreground running status, this usually indicates that a corresponding intervening communication event was disconnected, for example, the intervening communication event may disconnect due to a disconnecting operation (directly disconnecting while unconnected, or hanging up while connected) implemented by the current user, or due to non-processing by the current user, waiting for a timeout to automatically disconnect, and the like.

In other words, when the application process of the video conference being restored from a background running status to a foreground running status is detected by monitoring, this indicates that video conferencing may make normal use of, for example, screen display, speaker playback, camera acquisition and such permissions, and the intervening communication event, due to not having the above-mentioned permissions, will not impact the normal implementation of video conferencing, and thus it may be decided that the current user does not have a need to respond to the corresponding intervening communication event.

Step 1316, the electronic device of user A sends a second reminder message to the server, and restores relevant local rendering.

Step 1318, the server sends the second alert message to user B, user C and the like.

According to the present example embodiment, steps 1316-1318 may reference steps 316-318 as illustrated by FIG. 3, which shall not be repeated herein.

Additionally, when the current user receives a reminder message from another user, aside from adjusting (such as implementing a display switch between FIG. 8 and FIG. 9) display content of a video window of a video communication page (or video conference page) corresponding to the other user, the electronic device of the current user may perform a prompting operation by at least one of the below-mentioned methods: vibration, “breathing light” flashing, causing video windows corresponding to the other user to appear as though breathing (for example, the edges resizing at high frequency, the contents shaking, and the like), causing the video window of the other user and the background of the video communication page to be switched (for example, as illustrated by FIG. 9, the display content of the comparatively small video window of user A and the comparatively large background of the entire video communication page are displayed switched) and the like.

Given this, through the above-mentioned prompting operations, while impacting a video communication procedure as little as possible, more forceful prompting for the current user is implemented, avoiding display switching such as that illustrated by FIGS. 8-9 being overlooked by the current user, helping the current user to truly heed and comprehend the real-time condition of the other user. Thus it is ensured that when the other user has a need to respond to an intervening communication event, the current user may pause the advancement of video communication on a timely basis, and when the other user does not have a need to respond to an intervening communication event, even if the current user temporarily departs due to pausing video communication, advancement of video communication may be restored on a timely basis.

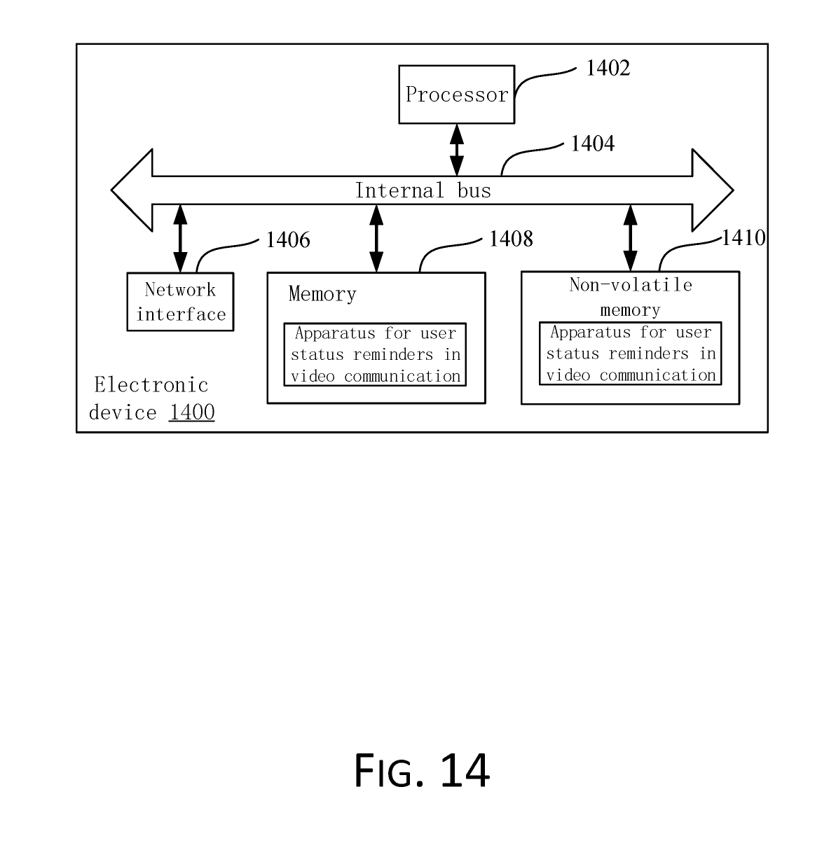

FIG. 14 is a schematic diagram of an electronic device 1400 provided by an exemplary example embodiment of the present disclosure. Referring to FIG. 14, at the hardware level, the electronic device 1400 includes one or more processor(s) 1402, an internal bus 1404, one or more network interface(s) 1406, memory 1408 and nonvolatile memory 1410, and of course may include hardware required for other services. The one or more processor(s) 1402 read(s) corresponding computer programs from the nonvolatile memory 1410 into the memory 1408 and then run(s) the computer programs, forming an apparatus for user status reminders in video communication (for example, an apparatus for user status reminders in video conferencing) at the logical level. Of course, aside from a software implementation, the present disclosure does not exclude other implementations, such as logic devices or a combination of software and hardware, and so on, which is to say that execution units of the main processing flow below are not limited to each respective logical unit, and may also be hardware or logic devices.

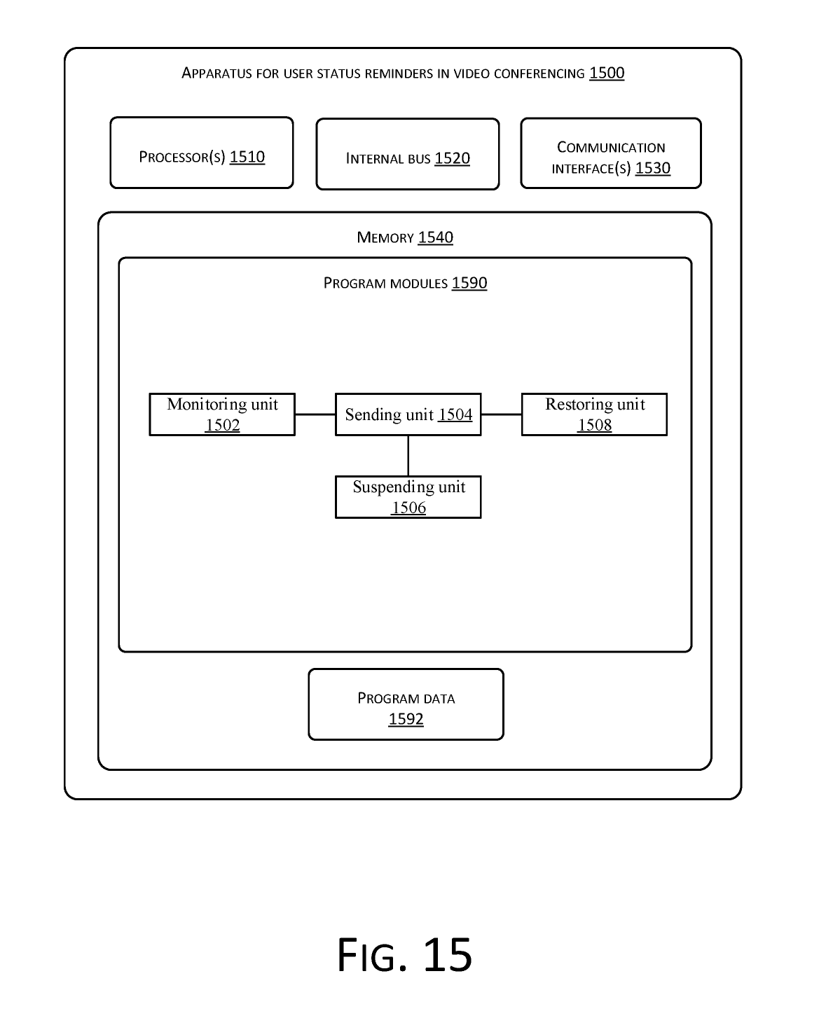

Referring to FIG. 15, an apparatus 1500 for user status reminders in video communication may include one or more processor(s) 1510, an internal bus 1520, one or more communication interface(s) 1530, and memory 1540, and may further include a monitoring unit 1502 and a sending unit 1504. Herein:

Memory 1540 is operative to store program instructions and/or data.

One or more processor(s) 1510, through reading program instructions and/or data stored on memory 1540, is/are operative to execute processes as follows:

The monitoring unit 1502 is stored in the memory 1540 and executable by the one or more processor(s) 1510 to cause the one or more processor(s) 1510 to, during a video communication procedure between a current user and another user, detect, by monitoring, an intervening communication event;

The sending unit 1504 is stored in the memory 1540 and executable by the one or more processor(s) 1510 to cause the one or more communication interface(s) 1530 to send a reminder message regarding the intervening communication event to the other user, the reminder message being operative to instruct as to whether the current user has a need to respond to the intervening communication event.

Optionally, the sending unit 1504 is further executable by the one or more processor(s) 1510 to:

Cause the one or more processor(s) 1510 to, based on a running status of an application process of video communication, determine whether the current user has a need to respond to the intervening communication event, and cause the one or more communication interface(s) 1530 to transmit a concordant reminder message to the other user.

Optionally:

The sending unit 1504 is further executable by the one or more processor(s) 1510 to, upon detecting, by monitoring, that the application process of the video communication is switched to a background running status, determine that the current user has a need to respond to the intervening communication event.

The sending unit 1504 is further executable by the one or more processor(s) 1510 to, upon detecting, by monitoring, that the application process of the video communication is restored from a background running status to a foreground running status, determine that the current user does not have a need to respond to the intervening communication event.

Optionally, the sending unit 1504 is further executable by the one or more processor(s) 1510 to:

Cause the one or more processor(s) 1510 to, based on a processing operation of the current user towards the intervening communication event, determine whether the current user has a need to respond to the intervening communication event, and cause the one or more communication interface(s) 1530 transmit a concordant reminder message to the other user.

Optionally:

The sending unit 1504 is further executable by the one or more processor(s) 1510 to, when the processing operation is a connecting response operation with regard to the intervening communication event, determine that the current user has a need to respond to the intervening communication event;

The sending unit 1504 is further executable by the one or more processor(s) 1510 to, when the processing operation is a disconnecting operation with regard to the intervening communication event, determine that the current user does not have a need to respond to the intervening communication event.

Optionally, further included are:

A suspending unit 1506 stored in the memory 1540 and executable by the one or more processor(s) 1510 to cause the one or more processor(s) 1510 to, when the processing operation is a connecting response operation with regard to the intervening communication event, suspend rendering operations relevant to the video communication;

A restoring unit 1508 stored in the memory 1540 and executable by the one or more processor(s) 1510 to cause the one or more processor(s) 1510 to, when the processing operation is a disconnecting operation with regard to the intervening communication event, restore rendering operations relevant to the video communication.

Optionally, the intervening communication event is a call event.

In implementations, the memory 1540 may include program units 1590 and program data 1592. The program units 1590 may include one or more of the units as described in above.

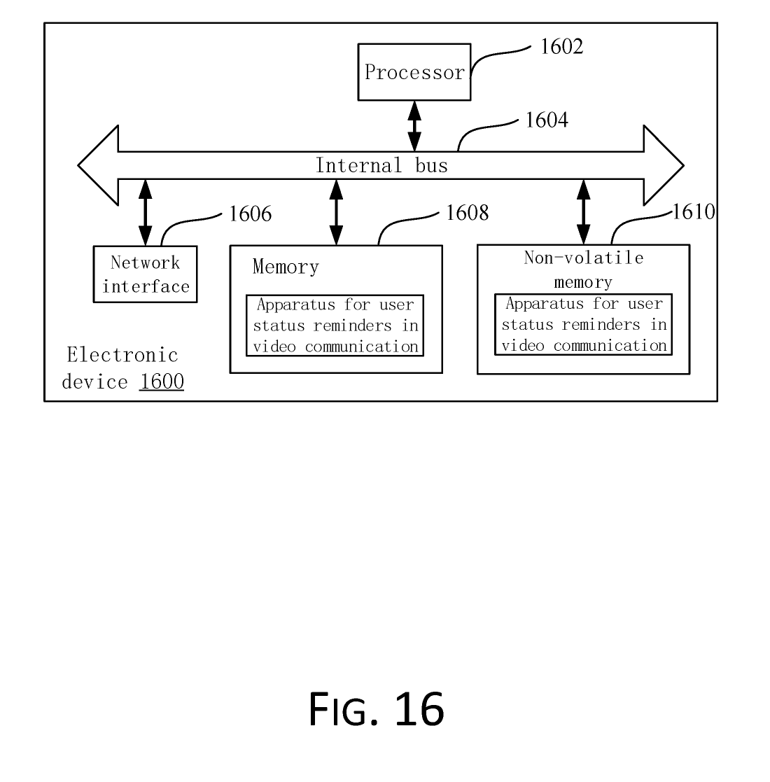

FIG. 16 is a schematic diagram of another electronic device provided by an exemplary example embodiment of the present disclosure. Referring to FIG. 16, at the hardware level, the electronic device includes one or more processor(s) 1602, an internal bus 1604, one or more network interface(s) 1606, memory 1608 and nonvolatile memory 1610, and of course may include hardware required for other services. The one or more processor(s) 1602 read(s) corresponding computer programs from the nonvolatile memory 1610 into the memory 1608 and then run(s) the computer programs, forming an apparatus for user status reminders in video communication (that is, an apparatus for user status reminders in video conferencing) at the logical level. Of course, aside from a software implementation, the present disclosure does not exclude other implementations, such as logic devices or a combination of software and hardware, and so on, which is to say that execution units of the main processing flow below are not limited to each respective logical unit, and may also be hardware or logic devices.

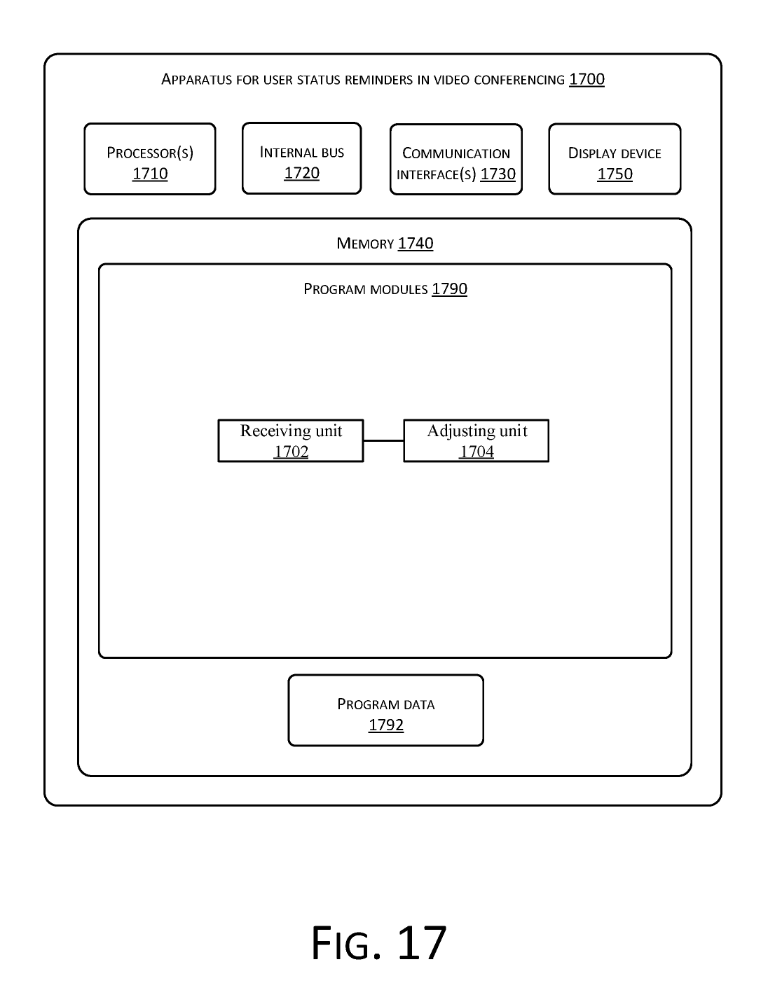

Referring to FIG. 17, an apparatus 1700 for user status reminders in video communication may include one or more processor(s) 1710, an internal bus 1720, one or more communication interface(s) 1730, memory 1740 and a display device 1750, and may further include a receiving unit 1702 and an adjusting unit 1704. Herein:

Memory 1740 is operative to store program instructions and/or data.

One or more processor(s) 1710, through reading program instructions and/or data stored on memory 1740, is/are operative to execute processes as follows:

The receiving unit 1702 is stored in the memory 1740 and executable by the one or more processor(s) 1710 to cause the one or more communication interface(s) 1730 to, during a video communication procedure between a current user and another user, receive a reminder message regarding the other user, the reminder message being operative to instruct as to whether the other user has a need to respond to the intervening communication event;

The adjusting unit 1704 is stored in the memory 1740 and executable by the one or more processor(s) 1710 to cause the one or more processors(s) 1710 to, based on the reminder message, adjusts display contents of a video window corresponding to the other user on a video communication page.

Optionally, the adjusting unit 1704 is further executable by the one or more processor(s) 1710 to:

Cause the display device 1750 to, when the other user has a need to respond to the intervening communication event, display user status information corresponding to the need to respond in the video window;

Cause the display device 1750 to, when the other user does not have a need to respond to the intervening communication event, display a video image of the other user in the video window.

In implementations, the memory 1740 may include program units 1790 and program data 1792. The program units 1790 may include one or more of the units as described in above.

According to a typical configuration, a computing device includes one or more processors (CPU), input/output interfaces, network interfaces, and memory.

Memory may include a volatile memory, a random access memory (RAM) and/or a non-volatile memory or the like in a computer-readable medium, for example, a read only memory (ROM) or a flash RAM. The memory is an example of the computer-readable medium.

The computer-readable medium includes non-volatile and volatile media as well as movable and non-movable media, and may implement information storage by means of any method or technology. Information may be a computer-readable instruction, a data structure, and a module of a program or other data. An example of the storage medium of a computer includes, but is not limited to, a phase-change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission medium, and may be used to store information accessible by the computing device. According to the definition in this text, the computer-readable medium does not include transitory computer-readable media (transitory media) such as a modulated data signal and carrier.

It should also be noted that the terms “include,” “including,” or any other variations thereof are intended to cover non-exclusive inclusions, such that the inclusion of a series of elements in a process, method, article, or apparatus includes not only those elements, but also includes other elements not explicitly listed, or include elements that are inherent to such processes, methods, article, or apparatus. Where no further limitation is given, an element defined by the phrase “includes a . . . ” does not exclude the existence of another identical element in the process, method, article, or apparatus including the element.

Exemplary example embodiments are described in detail herein with examples being indicated in drawings. Where the above description involves drawings, unless otherwise indicated, same numbers in different drawings indicate same or similar elements. Methods of implementation described by the above exemplary embodiments do not represent all methods of implementation which are consistent with the present disclosure. Rather, they are only examples of apparatuses and methods consistent with some aspects of the present disclosure, as detailed by the claims.

Terminology used by the present disclosure is merely for the purpose of describing particular example embodiments, which is not intended to limit the present disclosure. The use of singular forms “a” and “the” in the present disclosure and the claims is intended to include the plural forms thereof, unless the context clearly indicates other meaning. It should also be understood that the term “and/or” as used herein refers to containing any or all possible combinations of one or more relevant listed items.

It should be appreciated that, although the present disclosure may utilize the terms first, second, third and the like to describe a variety of information, such information should not be limited by these terms. These terms are only used to distinguish information of a same type from each other. For example, without departing from the scope of the present disclosure, a first information may also be designated as a second information, and, similarly, a second information may also be designated as a first information. Depending on the context, the language “if” may be construed as “when . . . ” or “upon . . . ” or “in response to determining.”

The foregoing is only preferred example embodiments of the present disclosure, not intended to limit the present disclosure, and any modifications, equivalent substitutions, improvements and the like made within the spirit and principle of the present disclosure shall fall within the scope of protection of the present disclosure.

The present disclosure may further be understood with clauses as follows.

Clause 1. A method for user status reminders in video communication, comprising:
during a video communication procedure between a current user and another user, detecting, by monitoring, an intervening communication event; and
sending a reminder message regarding the intervening communication event to the other user, the reminder message being operative to instruct as to whether the current user has a need to respond to the intervening communication event.

Clause 2. The method of clause 1, wherein sending a reminder message regarding the intervening communication event to the other user comprises:
based on a running status of the application process of video communication, determining whether the current user has a need to respond to the intervening communication event, and transmitting a concordant reminder message to the other user.

Clause 3. The method of clause 2, wherein based on the running status of the application process of video communication, determining whether the current user has a need to respond to the intervening communication event comprises:
upon detecting, by monitoring, that the application process of the video communication is switched to a background running status, determining that the current user has a need to respond to the intervening communication event;
upon detecting, by monitoring, that the application process of the video communication is restored from a background running status to a foreground running status, determining that the current user does not have a need to respond to the intervening communication event.

Clause 4. The method of clause 1, wherein sending a reminder message regarding the intervening communication event to the other user comprises:
based on a processing operation of the current user towards the intervening communication event, determining whether the current user has a need to respond to the intervening communication event, and transmitting a concordant reminder message to the other user.

Clause 5. The method of clause 4, wherein based on a processing operation of the current user towards the intervening communication event, determining whether the current user has a need to respond to the intervening communication event comprises:
when the processing operation is a connecting response operation with regard to the intervening communication event, determining that the current user has a need to respond to the intervening communication event; and
when the processing operation is a disconnecting operation with regard to the intervening communication event, determining that the current user does not have a need to respond to the intervening communication event.

Clause 6. The method of clause 5, further comprising:
when the processing operation is a connecting response operation with regard to the intervening communication event, suspending rendering operations relevant to the video communication;
when the processing operation is a disconnecting operation with regard to the intervening communication event, restoring rendering operations relevant to the video communication.

Clause 7. The method of clause 1, wherein the intervening communication event is a call event.

Clause 8. A method for user status reminders in video communication, comprising:
during a video communication procedure between a current user and another user, receiving a reminder message regarding the other user, the reminder message being operative to instruct as to whether the other user has a need to respond to the intervening communication event; and
based on the reminder message, adjusting display contents of a video window corresponding to the other user on a video communication page.

Clause 9. The method of clause 8, wherein based on the reminder message, adjusting display contents of a video window corresponding to the other user on a video communication page comprises:
when the other user has a need to respond to the intervening communication event, displaying user status information corresponding to the need to respond in the video window; and
when the other user does not have a need to respond to the intervening communication event, displaying a video image of the other user in the video window.

Clause 10. An apparatus for user status reminders in video communication, comprising:
a monitoring unit, which, during a video communication procedure between a current user and another user, detects, by monitoring, an intervening communication event; and
a sending unit, which sends a reminder message regarding the intervening communication event to the other user, the reminder message being operative to instruct as to whether the current user has a need to respond to the intervening communication event.

Clause 11. The apparatus of clause 10, wherein the sending unit further:
based on a running status of an application process of video communication, determines whether the current user has a need to respond to the intervening communication event, and transmits a concordant reminder message to the other user.

Clause 12. The apparatus of clause 11, wherein:
upon detecting, by monitoring, that the application process of the video communication is switched to a background running status, the sending unit determines that the current user has a need to respond to the intervening communication event; and
upon detecting, by monitoring, that the application process of the video communication is restored from a background running status to a foreground running status, the sending unit determines that the current user does not have a need to respond to the intervening communication event.

Clause 13. The apparatus of clause 10, wherein the sending unit further:
based on a processing operation of the current user towards the intervening communication event, determines whether the current user has a need to respond to the intervening communication event, and transmits a concordant reminder message to the other user.

Clause 14. The apparatus of clause 13, wherein:
when the processing operation is a connecting response operation with regard to the intervening communication event, the sending unit determines that the current user has a need to respond to the intervening communication event;
when the processing operation is a disconnecting operation with regard to the intervening communication event, the sending unit determines that the current user does not have a need to respond to the intervening communication event.

Clause 15. The apparatus of clause 14, further comprising:
a suspending unit which, when the processing operation is a connecting response operation with regard to the intervening communication event, suspends rendering operations relevant to the video communication; and
a restoring unit which, when the processing operation is a disconnecting operation with regard to the intervening communication event, restores rendering operations relevant to the video communication.

Clause 16. The apparatus of clause 10, wherein the intervening communication event is a call event.

Clause 17. An apparatus for user status reminders in video communication, comprising:
a receiving unit, which, during a video communication procedure between a current user and another user, receives a reminder message regarding the other user, the reminder message being operative to instruct as to whether the other user has a need to respond to the intervening communication event; and
an adjusting unit, which, based on the reminder message, adjusts display contents of a video window corresponding to the other user on a video communication page.

Clause 18. The apparatus of clause 17, wherein the adjusting unit further:
when the other user has a need to respond to the intervening communication event, displays user status information corresponding to the need to respond in the video window;
when the other user does not have a need to respond to the intervening communication event, displays a video image of the other user in the video window.

What is claimed is:

1. A method comprising:
detecting, by monitoring during a video communication procedure between a current user and another user, an intervening communication event; and
sending a reminder message regarding the intervening communication event to the other user, the reminder message being operative to instruct as to whether the current user has a need to respond to the intervening communication event.

2. The method of claim 1, wherein sending a reminder message regarding the intervening communication event to the other user comprises:
determining, based on a running status of the application process of video communication, whether the current user has a need to respond to the intervening communication event, and transmitting a concordant reminder message to the other user.

3. The method of claim 2, wherein determining, based on the running status of the application process of video communication, whether the current user has a need to respond to the intervening communication event comprises:
determining, upon detecting, by monitoring, that the application process of the video communication is switched to a background running status, that the current user has a need to respond to the intervening communication event;
determining, upon detecting, by monitoring, that the application process of the video communication is restored from a background running status to a foreground running status, that the current user does not have a need to respond to the intervening communication event.

4. The method of claim 1, wherein sending a reminder message regarding the intervening communication event to the other user comprises:
determining, based on a processing operation of the current user towards the intervening communication event, whether the current user has a need to respond to the intervening communication event, and transmitting a concordant reminder message to the other user.

5. The method of claim 4, wherein determining, based on a processing operation of the current user towards the intervening communication event, whether the current user has a need to respond to the intervening communication event comprises:
determining, upon determining that the processing operation is a connecting response operation with regard to the intervening communication event, that the current user has a need to respond to the intervening communication event; and
determining, upon determining that the processing operation is a disconnecting operation with regard to the intervening communication event, that the current user does not have a need to respond to the intervening communication event.

6. The method of claim 5, further comprising:
suspending, upon determining that the processing operation is a connecting response operation with regard to the intervening communication event, rendering operations relevant to the video communication;
restoring, upon determining that the processing operation is a disconnecting operation with regard to the intervening communication event, rendering operations relevant to the video communication.

7. The method of claim 4, wherein determining, based on a processing operation of the current user towards the intervening communication event, whether the current user has a need to respond to the intervening communication event comprises:
determining, upon determining that the processing operation is a disconnecting operation upon the unconnected intervening communication event, that the current user does not have a need to respond to the intervening communication event.

8. The method of claim 1, wherein the intervening communication event is a call event.

9. The method of claim 1, wherein the video communication procedure and the intervening communication event are respectively implemented by different communication methods.

10. A method for user status reminders in video communication, comprising:
receiving, during a video communication procedure between a current user and another user, a reminder message regarding the other user, the reminder message being operative to instruct as to whether the other user has a need to respond to the intervening communication event; and
adjusting, based on the reminder message, display contents of a video window corresponding to the other user on a video communication page.

11. The method of claim 10, wherein adjusting, based on the reminder message, display contents of a video window corresponding to the other user on a video communication page comprises:
displaying, upon determining that the other user has a need to respond to the intervening communication event, user status information corresponding to the need to respond in the video window; and
displaying, upon determining that the other user does not have a need to respond to the intervening communication event, a video image of the other user in the video window.

12. An apparatus for user status reminders in video communication, comprising:
one or more processors;
memory;
one or more communication interfaces;
a monitoring unit stored in the memory and executable by the one or more processors to cause the one or more processors to detect, by monitoring during a video communication procedure between a current user and another user, an intervening communication event; and
a sending unit stored in the memory and executable by the one or more processors to cause the one or more communication interfaces to send a reminder message regarding the intervening communication event to the other user, the reminder message being operative to instruct as to whether the current user has a need to respond to the intervening communication event.

13. The apparatus of claim 12, wherein the sending unit is further executable by the one or more processors to:
cause the one or more processors to determine, based on a running status of an application process of video communication, whether the current user has a need to respond to the intervening communication event, and cause the one or more communication interfaces to transmit a concordant reminder message to the other user.

14. The apparatus of claim 13, wherein:
the sending unit is further executable by the one or more processors to cause the one or more processors to determine, upon detecting, by monitoring, that the application process of the video communication is switched to a background running status, that the current user has a need to respond to the intervening communication event; and
the sending unit is further executable by the one or more processors to cause the one or more processors to determine, upon detecting, by monitoring, that the application process of the video communication is restored from a background running status to a foreground running status, that the current user does not have a need to respond to the intervening communication event.

15. The apparatus of claim 12, wherein the sending unit is further executable by the one or more processors to:
cause the one or more processors to determine, based on a processing operation of the current user towards the intervening communication event, whether the current user has a need to respond to the intervening communication event, and cause the one or more communication interfaces to transmit a concordant reminder message to the other user.

16. The apparatus of claim 15, wherein:
the sending unit is further executable by the one or more processors to cause the one or more processors to determine, upon determining that the processing operation is a connecting response operation with regard to the intervening communication event, that the current user has a need to respond to the intervening communication event;
the sending unit is further executable by the one or more processors to cause the one or more processors to determine, upon determining that the processing operation is a disconnecting operation with regard to the intervening communication event, that the current user does not have a need to respond to the intervening communication event.

17. The apparatus of claim 16, further comprising:
a suspending unit stored in the memory and executable by the one or more processors to cause the one or more processors to suspend, upon determining that the processing operation is a connecting response operation with regard to the intervening communication event, rendering operations relevant to the video communication; and
a restoring unit stored in the memory and executable by the one or more processors to cause the one or more processors to restore, upon determining that the processing operation is a disconnecting operation with regard to the intervening communication event, rendering operations relevant to the video communication.

18. The apparatus of claim 15, wherein:
the sending unit is further executable by the one or more processors to cause the one or more processors to determine, upon determining that the processing operation is a disconnecting operation upon the unconnected intervening communication event, that the current user does not have a need to respond to the intervening communication event.

19. The apparatus of claim 12, wherein the intervening communication event is a call event.

20. The apparatus of claim 12, wherein the video communication procedure and the intervening communication event are respectively implemented by different communication methods.
